(19) United States
(12) Patent Application Publication
(10) Pub. No.: US 2026/0203679 A1
(43) Pub. Date: Jul. 16, 2026

(54) SYSTEMS AND METHODS FOR PARKING MANAGEMENT

(71) Applicant: Ford Global Technologies, LLC, Dearborn, MI (US)

(72) Inventors: Ryan O'Gorman, Beverly Hills, MI (US); Stuart C. Salter, White Lake, MI (US); Krishna Bandi, Novi, MI (US); Mario Anthony Santillo, Canton, MI (US); Brendan Diamond, Naples, FL (US); Vyas Darshan Shenoy, Canton, MI (US)

(73) Assignee: Ford Global Technologies, LLC, Dearborn, MI (US)

(21) Appl. No.: 19/018,444

(22) Filed: Jan. 13, 2025

(51) Int. Cl. G06Q 10/0631; B62D 65/00

(52) U.S. Cl. CPC G06Q 10/06311; B62D 65/00; G06Q 2240/00

(57) ABSTRACT

A method includes the receipt of an access-related request associated with a vehicle, a determination of whether a task associated with the access-related request can be performed within a time-related threshold, an aggregation of the access-related request with a plurality of pending access-related requests in response to determining that the access-related request cannot be performed within the time-related threshold, and causing a pose associated with the vehicle to shift.

### FIELD

The present disclosure relates to a parking management system, and more particularly, a parking management system providing accessibility to a vehicle based on one or more use-cases associated with the vehicle.

### BACKGROUND

The statements in this section merely provide background information related to the present disclosure and may not constitute prior art.

Large numbers of vehicles can be stored within parking locations at any given time between manufacture and delivery. However, storing such a large number of vehicles has inherent challenges associated with the management of vehicle inventory as vehicles are marshaled in and out of the parking location for various needs. Such challenges can relate to efficient utilization of space within the parking location, optimization of access, among others. Inefficiencies related to typical methods and/or systems relied upon to manage the vehicle inventory within parking locations can also exist, such as an inability to optimally rearrange vehicles within the parking location and/or being unable to predict a time required for the rearrangement of vehicles within the parking location.

The present disclosure addresses these and other issues related to the management of an inventory of parked vehicles within a marshaling environment.

### SUMMARY

This section provides a general summary of the disclosure and is not a comprehensive disclosure of its full scope or all of its features.

The present disclosure provides a method comprising: receiving, by an infrastructure system, an access-related request associated with a vehicle; determining whether a first task associated with the access-related request can be performed within a time-related threshold; aggregating the access-related request with a plurality of pending access-related requests in response to determining that the access-related request cannot be performed within the time-related threshold; and causing a pose associated with the vehicle to shift in response to the aggregation of the access-related request with the plurality of pending access-related requests; wherein the access-related request includes one or more vehicle characteristics, a location associated with a performance of the first task, a priority associated with the first task, the time-related threshold associated with the first task, an expected duration to complete performance of the first task, or a combination thereof; wherein each access-related request of the pending access-related requests is associated with a second task, and wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof; further comprising: determining whether the expected duration to complete performance of the second task satisfies the time-related threshold associated with the first task; and causing the second task to be performed in parallel to the first task being performed on the vehicle in response to determining that the expected duration to complete performance of the second task satisfies the time-related threshold associated with the first task; further comprising: assigning a priority to one or more parking locations within a marshaling environment based on an accessibility associated with each parking location of the one or more parking locations; assigning the vehicle to a parking location of the one or more parking locations in response to a completion of the first task performed on the vehicle; and causing the vehicle to proceed to the parking location in response to the assignment of the vehicle to the parking location; wherein the assignment of the vehicle to the parking location further comprises: matching an expected duration of parking the vehicle within the marshaling environment to the assigned priority of the parking location; and wherein the pose associated with the vehicle includes a position and a location that corresponds to the vehicle, and wherein causing the pose associated with the vehicle to shift further comprises: determining a future position and location that allows access for one or more tasks to be performed on another vehicle; and causing the vehicle to proceed to the future position and location.

The present disclosure provides a system comprising: an infrastructure system configured to: receive an access-related request associated with a vehicle, determine whether a first task associated with the access-related request can be performed within a time-related threshold, aggregate the access-related request with a plurality of pending access-related requests in response to determining that the access-related request cannot be performed within the time-related threshold, and cause a pose associated with the vehicle to shift in response to the aggregation of the access-related request with the plurality of pending access-related requests; and the vehicle configured to: receive, from the infrastructure system, one or more marshaling commands, and shift the pose associated with the vehicle in response to receiving the one or more marshaling commands; wherein the access-related request includes one or more vehicle characteristics, a location associated with a performance of the first task, a priority associated with the first task, the time-related threshold associated with the first task, an expected duration to complete performance of the first task, or a combination thereof; wherein each access-related request of the pending access-related requests is associated with a second task, and wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof; wherein the infrastructure is further configured to: determine whether the expected duration to complete performance of the second task satisfies the time-related threshold associated with the first task; and cause the second task to be performed in parallel to the first task being performed on the vehicle in response to determining that the expected duration to complete performance of the second task satisfies the time-related threshold associated with the first task; wherein the infrastructure is further configured to: assign a priority to one or more parking locations within a marshaling environment based on an accessibility associated with each parking location of the one or more parking locations; assign the vehicle to a parking location of the one or more parking locations in response to a completion of the first task performed on the vehicle; and cause the vehicle to proceed to the parking location in response to the assignment of the vehicle to the parking location; wherein the infrastructure system configured to assign the vehicle to the parking location is further configured to: match an expected duration of parking the vehicle within the marshaling environment to the assigned priority of the parking location; and wherein the pose associated with the vehicle includes a position and a location that corresponds to the vehicle, and wherein the infrastructure system configured to cause the pose associated with the vehicle to shift is further configured to: determine a future position and location that allows access for one or more tasks to be performed on another vehicle; and cause the vehicle to proceed to the future position and location.

The present disclosure provides one or more non-transitory computer-readable media storing processor-executable instructions that, when executed by at least one processor, cause the at least one processor to: receive an access-related request associated with a vehicle; determine whether a first task associated with the access-related request can be performed within a time-related threshold; aggregate the access-related request with a plurality of pending access-related requests in response to determining that the access-related request cannot be performed within the time-related threshold; and cause a pose associated with the vehicle to shift in response to the aggregation of the access-related request with the plurality of pending access-related requests; wherein the access-related request includes one or more vehicle characteristics, a location associated with a performance of the first task, a priority associated with the first task, the time-related threshold associated with the first task, an expected duration to complete performance of the first task, or a combination thereof, and wherein each access-related request of the pending access-related requests is associated with a second task, and further wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof; wherein the at least one processor is further caused to: determine whether the expected duration to complete performance of the second task satisfies the time-related threshold associated with the first task; and cause the second task to be performed in parallel to the first task being performed on the vehicle in response to determining that the expected duration to complete performance of the second task satisfies the time-related threshold associated with the first task; wherein the at least one processor is further caused to: assign a priority to one or more parking locations within a marshaling environment based on an accessibility associated with each parking location of the one or more parking locations; assign the vehicle to a parking location of the one or more parking locations in response to a completion of the first task performed on the vehicle; and cause the vehicle to proceed to the parking location in response to the assignment of the vehicle to the parking location; wherein the at least one processor caused to assign the vehicle to the parking location is further caused to: match an expected duration of parking the vehicle within the marshaling environment to the assigned priority of the parking location; and wherein the pose associated with the vehicle includes a position and a location that corresponds to the vehicle, and wherein the at least one processor caused to cause the pose associated with the vehicle to shift is further caused to: determine a future position and location that allows access for one or more tasks to be performed on another vehicle; and cause the vehicle to proceed to the future position and location.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a system for automated vehicle marshaling in accordance with one or more embodiments of the present disclosure;

FIG. 2 illustrates an example vehicle marshaled by the system shown in FIG. 1 in accordance with one or more embodiments of the present disclosure;

FIGS. 3A-3D is a process flow diagram illustrating an example method for parking management of one or more vehicles;

FIG. 4 illustrates a display depicting a marshaling environment in accordance with one or more embodiments of the present disclosure;

FIG. 5 is a flowchart illustrating an example method for parking management of one or more vehicles in accordance with one or more embodiments of the present disclosure; and

FIG. 6 is a block diagram illustrating an example computer system in accordance with one or more embodiments of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

One or more herein described examples provide systems and methods for parking management of one or more vehicles. More specifically, the systems and methods of the present disclosure provide a means for optimizing parking locations and/or oriented zones therein based on a use-case associated with each vehicle, a time required to move each vehicle into a particular organization for a particular purpose and/or access, as well as a duration of a particular task to be performed on each vehicle within a schedule. In one or more examples, the systems and methods of the present disclosure can provide for a systematic organization of vehicles for multiple purposes in a sequential manner over time and/or within different allocations of time for one or more purposes to reduce a number of times vehicles are required to be shuffled (or moved) within the parking location or to reduce the number of times reorganization of the vehicles are scheduled. This systematic organization can reduce the time required by system operators to find and interact with the vehicles, which enhances operational efficiencies in general.

In one or more examples, the systems and methods of the present disclosure can provide for the de-prioritization of access associated with moving vehicles schedule for less urgent tasks and then re-prioritizing the same vehicles when more urgent tasks are scheduled to be performed on the vehicles. In one or more examples, the systems and methods of the present disclosure can provide for the prioritization of a group of vehicles based on a scheduled task related to each vehicle of the group of vehicles, which effectively organizes the vehicles in a manner where the system operator can perform the task(s) on each vehicle of the group of vehicles in the same area of the parking location, which saves time for the system operator who would otherwise have to move through all the vehicles parked in the parking location to perform the task(s).

In one or more examples, the systems and methods of the present disclosure can provide for the prioritization of inventory management relative to the vehicle inventory associated with the parking location so that the vehicle inventory is dynamically rearranged to allow for the accommodation of new vehicles at any time without affecting access to prioritized vehicles scheduled for service. In one or more examples, the systems and methods of the present disclosure provide for the prediction of a time associated with the rearrangement of vehicles, as well as the completion of an action as a basis for reducing the total number of vehicles required to be moved, which effectively reduces the overall time for rearranging the vehicles in general.

In one or more examples, the systems and methods of the present disclosure allow for service operators to perform the task(s) in a more efficient manner by prioritizing and aggregating requests based on input from a requesting party to ensure the task(s) are completed based on priority, as well as providing a means and opportunity for multiple tasks to be completed on the same vehicle at the same time.

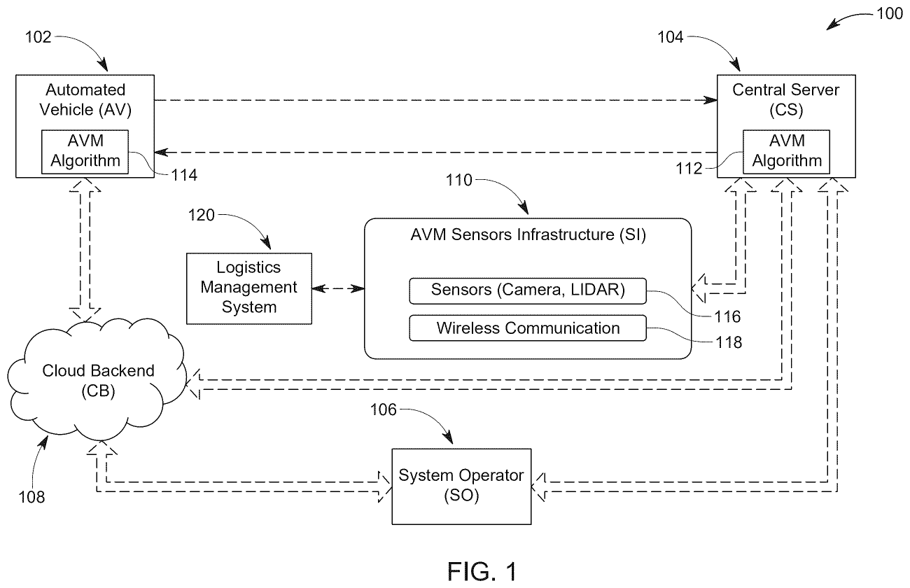

FIG. 1 shows a schematic block diagram illustrative of an automated vehicle marshaling (AVM) system 100. In one or more examples, the AVM system 100 marshals one or more vehicles (e.g., a vehicle 102) traveling at a low speed. However, it is understood that the AVM system 100 may marshal the one or more vehicles traveling at any speed. It is also understood that the AVM system 100 may marshal semi-autonomous vehicles and/or fully autonomous vehicles.

The AVM system 100 generally includes the vehicle 102, a central server 104, a system operator 106, a cloud system 108, and an infrastructure system 110. The central server 104 operates as a central point of communication related to the AVM system 100 and manages and/or facilitates any manufacturing process associated with the vehicle 102. For example, the central server 104 facilitates marshaling of the one or more vehicles, which causes the one or more vehicles to travel through (e.g., traverse) a marshaling environment (e.g., a factory floor or parking lot).

The central server 104 is configured to wirelessly communicate directly with each of the components of the AVM system 100 (e.g., the vehicle 102, the system operator 106, the cloud system 108, and the infrastructure system 110) and can include an infrastructure-side AVM algorithm 112. The central server 104 is also configured to provide logical interface information received from the infrastructure system 110 to the vehicle 102. Additionally, the central server 104 is configured to calculate one or more maneuvers (e.g., movements) associated with the vehicle 102.

The infrastructure-side AVM algorithm 112 processes status information associated with at least the vehicle 102 of the one or more vehicles. It is understood that the infrastructure-side AVM algorithm 112 processes status information associated with each vehicle of the one or more vehicles. The central server 104 is configured to utilize the infrastructure-side AVM algorithm 112 to transmit one or more instructions and/or process information received from each of the components of the AVM system 100 (e.g., the vehicle 102, the system operator 106, the cloud system 108, and the infrastructure system 110). For example, the received information can be related to, but is not limited to, marshaling the vehicle 102 and/or visual based communication with the vehicle 102.

Particularly, based on the direct communication with the one or more vehicles, the central server 104 is further configured to cause the one or more vehicles to start, stop (e.g., at a particular parking location), or pause progression through the marshaling environment. The central server 104 is further configured to control a marshaling speed of the one or more vehicles as the one or more vehicles travel through the marshaling environment.

The vehicle 102 includes a vehicle-side AVM algorithm 114. In one or more embodiments, the vehicle 102 utilizes the vehicle-side AVM algorithm 114 to process and send information gathered by one or more components associated with the construct of the vehicle 102, such as a component internally and/or externally disposed related to the vehicle 102. For example, although not shown, the components associated with the construct of the vehicle 102 can include a wireless transmission module, a vehicle central gateway module, a vehicle infotainment system, one or more vehicle sensors, a vehicle battery, a vehicle global navigation satellite (e.g., GNSS), a vehicle navigation mapping system, and/or a controller area network (CAN) vehicle bus. It is understood that marshaling of the vehicle 102 within the AVM system 100 can be supported by the utilization of any of the one or more components associated with the construct of the vehicle 102.

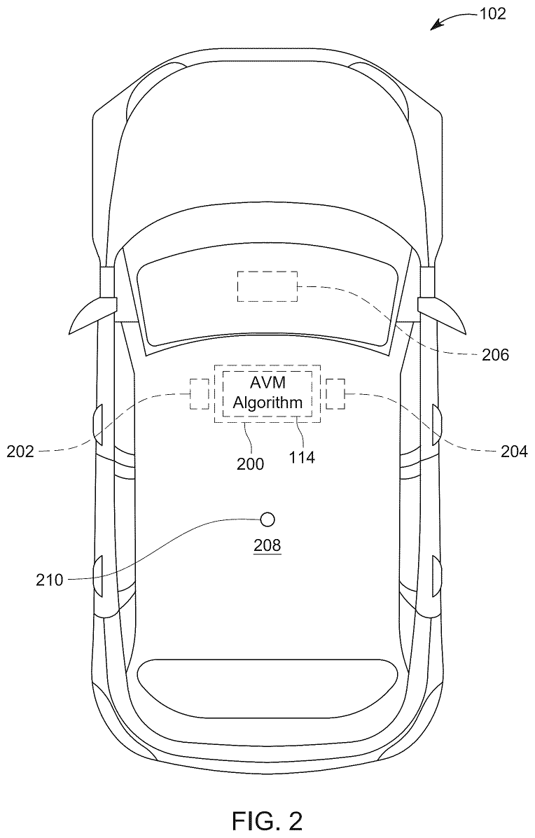

More particularly, and with reference to FIG. 2, in various forms, the vehicle(s) 102 may be powered in a variety of ways, for example, with an electric motor and/or an internal combustion engine. It is understood that the vehicle(s) 102 may be any type of vehicle powered by an electric motor and/or an internal combustion engine such as a car, a truck, a robot, a plane, and/or a boat. The vehicle(s) 102 generally includes the vehicle controller 200, one or more actuators 202, a plurality of on-board sensors 204, a human machine interface (HMI) 206, and a vehicle system 208. The vehicle(s) 102 also has a reference point 210, that is, a specified point within a space defined by a vehicle body that identifies the location of the vehicle(s) 102. For example, the reference point 210 is a geometrical center point at which respective longitudinal and lateral center axes of the vehicle(s) 102 intersects. As another example, the reference point 210 is a point at which the vehicle(s) 102 is located as the vehicle(s) 102 navigates toward a waypoint, such as to park the vehicle 102.

The vehicle controller 200, in some examples, is configured or programmed to control the operation of one or more of vehicle brakes, propulsion (e.g., control of acceleration in the vehicle(s) 102 by controlling one or more of an internal combustion engine, electric motor, hybrid engine, etc.), steering, climate control, interior and/or exterior lights, etc. The vehicle controller 200, in other examples, is further configured or programed to determine whether and when the vehicle controller 200, as opposed to a human operator, is to control such operations related to the vehicle(s) 102. It is understood that any of the operations associated with the vehicle(s) 102 may be facilitated via an automated, a semi-automated, or a manual mode. For example, the automated mode may facilitate any of the operations to be fully controlled by the vehicle controller 200 without the aid of the human operator. As another example, the semi-automated mode may facilitate any of the operations to be at least partially controlled by the human operator in combination with the vehicle controller 200. As a further example, the manual mode may facilitate the operations to be fully controlled by the human operator without the aid of the vehicle controller 200.

The vehicle controller 200 includes, or may be communicatively coupled to (e.g., via a vehicle communications bus), one or more processors (not shown). For example, the one or more processors can be a controller, or the like, included in the vehicle(s) 102 for monitoring and/or controlling various vehicle controllers, such as a powertrain controller, a brake controller, a steering controller, etc. The vehicle controller 200 is generally arranged for communications on a vehicle communication network (not shown) that can include a bus in the vehicle(s) 102 such as a CAN bus, or the like, and/or other wired and/or wireless mechanisms.

Via a vehicle network, the vehicle controller 200 transmits messages to various devices in the vehicle(s) 102 and/or receives messages from the various devices, for example, the one or more actuators 202, the HMI 206, etc. Alternatively, or additionally, in cases where the vehicle controller 200 includes multiple devices, the vehicle communication network is utilized for communications between such devices represented by the vehicle controller 200 in this disclosure. Further, as discussed below, various other controllers and/or sensors provide data to the vehicle controller 200 via the vehicle communication network.

In addition, the vehicle controller 200, via the vehicle-side AVM algorithm 114, is configured for communicating through a vehicle-to-infrastructure communication network, such as communicating with an infrastructure controller (not shown). The vehicle controller 200, via the vehicle-side AVM algorithm 114, is also configured for communicating through a wireless vehicular communication interface with other traffic objects (e.g., vehicles, infrastructures, etc.), such as, via a vehicle-to-vehicle communication network. The vehicular communication network represents one or more mechanisms by which the vehicle controller 200 of the vehicle(s) 102 communicates with other traffic objects. As an example, the vehicular communication network may be one or more of wireless communication mechanisms, including any desired combination of wireless (e.g., cellular, wireless, satellite, microwave, and/or radio frequency) communication mechanisms and any desired network topology (or topologies when multiple communication mechanisms are utilized). Examples of vehicular communication networks include, among others, cellular, Bluetooth®, IEEE 802.11, dedicated short range communications (DSRC), and/or wide area networks (WAN), including the Internet, providing data communication services.

The one or more actuators 202 are implemented via circuits, chips, or other electronic and/or mechanical components that can actuate various vehicle subsystems in accordance with appropriate control signals. The one or more actuators 202 may be used to control braking, acceleration, and/or steering of the vehicle(s) 102. The vehicle controller 200 can be programmed to activate the one or more actuators 202 including propulsion, steering, and/or braking based on the planned acceleration or deceleration of the vehicle(s) 102.

The plurality of on-board sensors 204 include a variety of devices to provide data to the vehicle controller 200. For example, the plurality of on-board sensors 204 may include object detection sensors (e.g., lidar sensor(s)) disposed on or in the vehicle(s) 102 that provide relative locations, sizes, and/or shapes of one or more objects surrounding the vehicle(s) 102, such as additional vehicles, bicycles, robots, drones, etc., travelling next to, ahead, and/or behind the vehicle(s) 102. As another example, one or more of the plurality of on-board sensors 204 can be radar sensors affixed to one or more bumpers of the vehicle(s) 102 that may provide locations of the object(s) relative to the location of each of the vehicles 102.

The plurality of on-board sensors 204 may include a camera sensor, for example, to provide a front view, side view, rear view, etc., providing images from an area surrounding the vehicle(s) 102. As another example, the vehicle controller 200 may be programmed to receive sensor data from a camera sensor(s) and to implement image processing techniques to detect a road, infrastructure elements, etc. The vehicle controller 200 may be further programmed to determine a current vehicle location based on location coordinates (e.g., GPS coordinates) received from the vehicle(s) 102 indicative of a location of the vehicle 102 determined from a GPS sensor (not shown).

The HMI 206 is configured to receive information from the human operator during operation of the vehicle(s) 102. Moreover, the HMI 206 is configured to present information to the human operator, such as, an occupant of the vehicle(s) 102. In some variations, the vehicle controller 200 is programmed to receive destination data (e.g., location coordinates) from the HMI 206.

The vehicle system 208 is configured to control each of the subsystems within the vehicle(s) 102 and facilitate requests across each of the above-described components (e.g., the vehicle controller 200, the one or more actuators 202, the plurality of on-board sensors 204, and/or the HMI 206). Accordingly, the vehicle(s) 102 can be autonomously guided toward a waypoint using at least the plurality of on-board sensors 204. Routing can be performed using vehicle location, distance to travel, queue in line for vehicle marshaling, etc.

Referring back to FIG. 1, and in one or more embodiments, in addition to or in alternative to the infrastructure system 110, the vehicle-side AVM algorithm 114 may determine the status information associated with the vehicle 102 based on processed information as is further described herein. In another one or more embodiments, the vehicle 102 utilizes the vehicle-side AVM algorithm 114 to process and send information obtained from any of the components associated with the construct of the vehicle 102 to the central server 104, and/or the cloud system 108. However, it is understood that the vehicle 102 can utilize the vehicle-side AVM algorithm 114 to process and send information obtained from any of the components associated with the construct of the vehicle 102 directly to the infrastructure system 110 and/or the system operator 106. Additionally, the vehicle-side AVM algorithm 114 is further configured to process and send information received from any of the components of the AVM system 100 to any of the components associated with the construct of the vehicle 102.

The central server 104 is configured to cause the infrastructure system 110 to monitor the progression of the one or more vehicles as the vehicle(s) move through the marshaling environment. The infrastructure system 110 includes a sensor component 116 and a wireless communication component 118. For example, the wireless communication component 118 may utilize GPS, Wi-Fi, satellite, 3G/4G/5G, and/or Bluetooth™ to communicate with the one or more vehicles. It is understood that by utilizing either of the sensor component 116 and/or the wireless communication component 118, the infrastructure system 110 is configured to perform localization function(s) associated with the marshaling of the vehicle 102, such as, but not limited to, perception, path-planning, detection, controls, response of the vehicle 102, or a combination thereof, among others.

The wireless communication component 118 communicates with the sensor component 116 that is configured to manage, for example, one or more of cameras, lidar, radar, and/or ultrasonic devices. The sensor component 116 monitors the movement of the one or more vehicles as the one or more vehicles are marshaled through the marshaling environment.

The system operator 106 can be a human operator tasked with monitoring the marshaled one or more vehicles by communicating with the cloud system 108. It is understood that the cloud system 108 is a backend system that may represent an original equipment manufacturer cloud system responsible for remote engagement and/or disengagement of AVM application(s) including enrollment and/or unenrollment of the vehicle 102 from the AVM system 100. In one or more embodiments, the system operator 106 communicates with the cloud system 108 and/or monitors the one or more vehicles via a user device (not shown) and/or a human eye of the human operator. However, it is understood that the system operator 106 can also be a non-human operator, such as a mainframe controller, a machine-learning based control system, or any neural network. It is also understood that the system operator 106 is tasked with managing and/or supervising operation of the vehicle 102 (e.g., via an in-facility interface) during automated marshaling, an onboarding process, and/or at individual locations. The system operator 106 is able to receive instructions from the central server 104 and forward those instructions on to the one or more vehicles, via the cloud system 108. For example, the instructions received from the central server 104 can be one or more marshaling commands that can cause the one or more vehicles to travel to a vehicle repair bay, a parking location, a future location, or any other location.

In one or more embodiments, the system operator 106 can obtain information associated with the operation of the vehicle 102. In one or more embodiments, the obtained information can be displayed on the user device based on one or more determinations made by a logistics management system 120 regarding parking the vehicle 102 within the marshaling environment. For example, the user device can be a tablet or any other suitable electronic device. As another example, the one or more determinations are made by utilizing at least the sensor component 116 of the infrastructure system 110 and/or the plurality of on-board sensors 204. In another one or more embodiments, the infrastructure system 110 is configured to communicate (e.g., via a wireless or a wired means) with the logistics management system 120. While the logistics management system 120 is depicted as externally disposed from the infrastructure system 110, it is understood that the logistics management system 120 can be internally disposed within the infrastructure system 110.

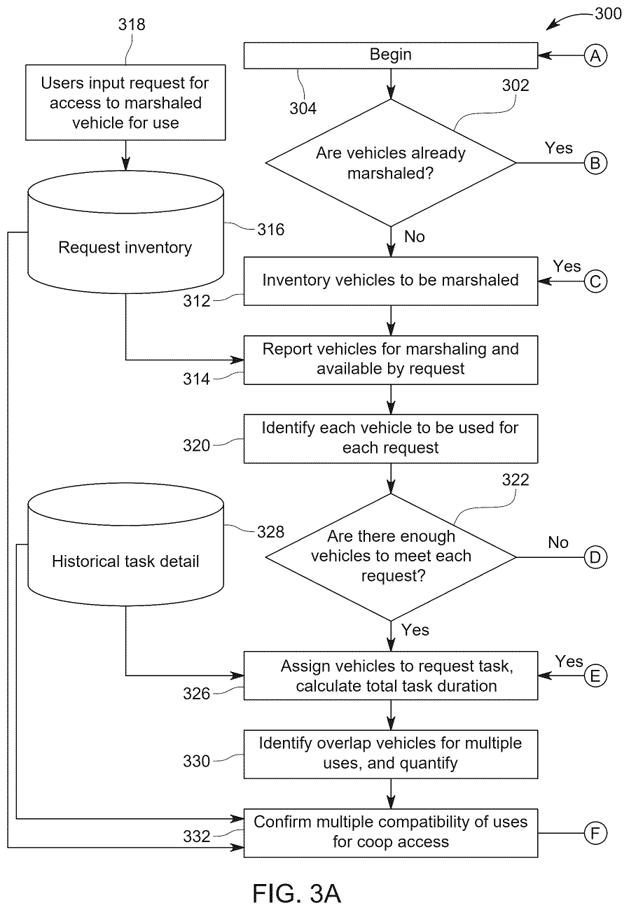

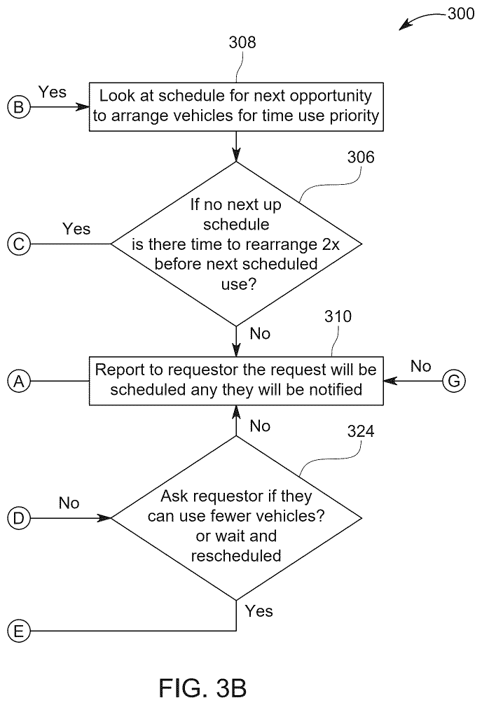

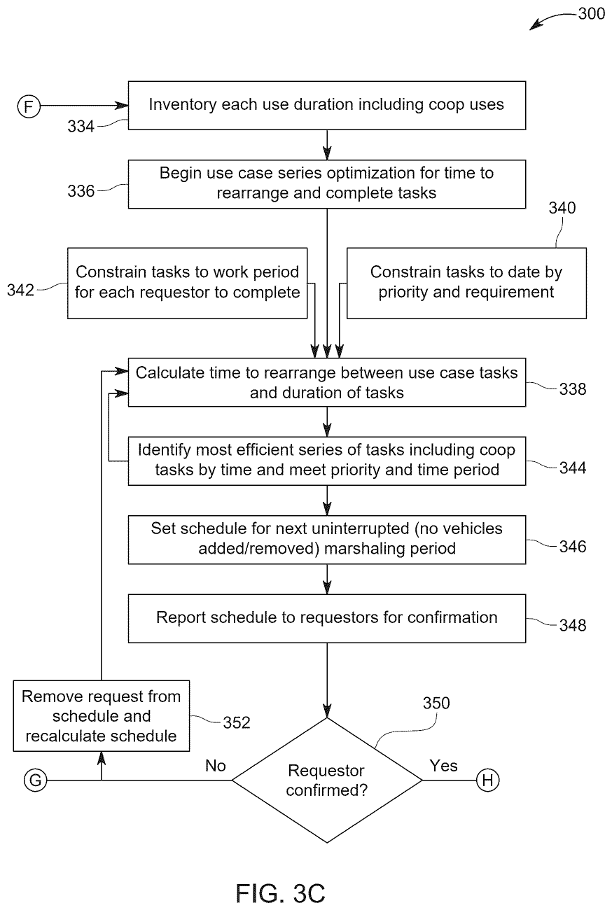

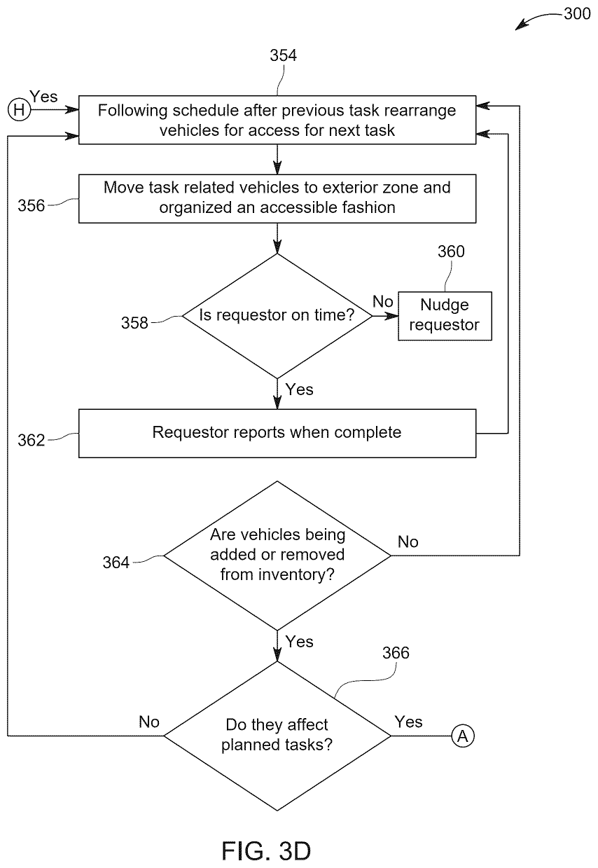

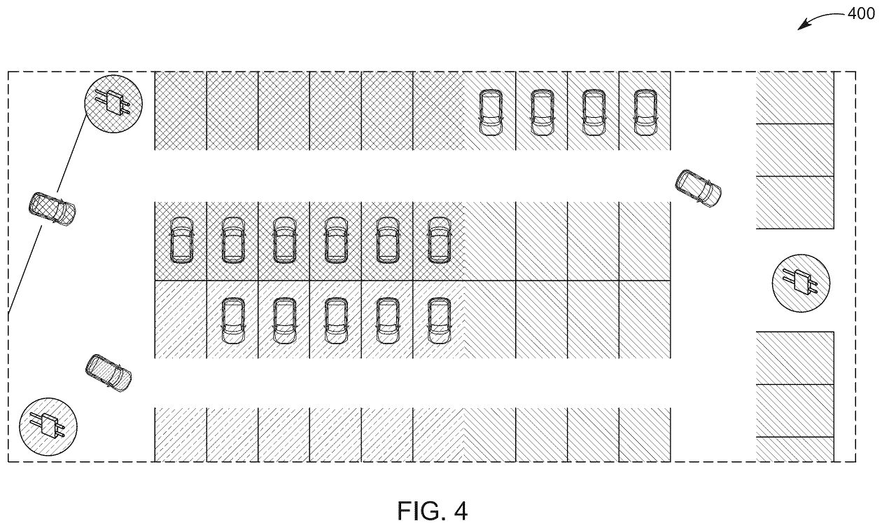

FIGS. 3A-3D illustrate a process flow showing steps 300 for optimizing management associated with parking one or more vehicles within a marshaling environment as described herein and according to one or more embodiments. In one or more examples, and as is shown in FIG. 4, the optimization of one or more parking management processes within a marshaling environment can be virtually displayed to the system operator 106 via a display 400 provided by the user device. As another example, the virtual display can be a virtual rendition (e.g., a digital twin) of the manufacturing facility that is color coded so that it is easily identifiable for the system operator 106 to observe instances wherein the infrastructure-AVM algorithm 112 causes a position of the vehicle 102 to be rearranged and how such a rearrangement of the vehicle 102 may affect access to the vehicle 102 in relation to other vehicles within the manufacturing facility.

In one or more embodiments, the infrastructure-side AVM algorithm 112 is configured to determine whether the vehicle 102 is ready to be marshaled at step 302. In one or more examples, the determination of whether the vehicle 102 is ready to be marshaled can be based on an initiation (at step 304) of the parking management process.

In an instance wherein a determination is made that the vehicle 102 is ready to be marshaled, the infrastructure-side AVM algorithm 112 is configured to determine whether there is time to rearrange a position of the vehicle 102 at least a second time before the vehicle 102 is scheduled to be used next at step 306. In one or more examples, the determination of whether there is time to rearrange a position of the vehicle 102 at least a second time before the vehicle 102 is scheduled to be used next can be based on a schedule (identified at step 308). The schedule can indicate available times corresponding to times when the position of the vehicle 102 can be rearranged, for example. In a case wherein a determination is made that there is not enough time to rearrange the position of the vehicle 102 at least a second time before the vehicle 102 is scheduled to be used next, a report can be transmitted (at step 310) to a requestor that can include a notification indicating that the request will be scheduled. As an example, the requestor can be any entity with an ability to initiate the parking management process such as a human operator, a neural network-powered device, a control system, among others. As another example, the report can cause for the parking management process to be re-initiated at step 304.

However, in a case wherein a determination is made that the vehicle 102 is not ready to be marshaled, the infrastructure-side AVM algorithm 112 is configured to add the vehicle 102 to an inventory of vehicles to be marshaled at step 312. Additionally, and in a case wherein a determination is made that there is enough time to rearrange the position of the vehicle 102 at least a second time before the vehicle 102 is scheduled to be used next, the infrastructure-side AVM algorithm 112 is also configured to add the vehicle 102 to an inventory of vehicles to be marshaled at step 312. It is understood that the vehicle 102 can be added to an inventory of vehicles to be marshaled based on the combination of the results of steps 302 and 306. However, it is also understood that the vehicle 102 can be added to an inventory of vehicles to be marshaled based on the individual results of steps 302 or 306.

The infrastructure-side AVM algorithm 112 is configured to report the inventory of vehicles to be marshaled that are available at step 314 based on a request inventory. As an example, the report can be transmitted to the requestor. In one or more examples, the request inventory can be stored in a first database 316. It is understood that the first database 316 can be provided internally within the infrastructure system 110 itself or externally in relation to the infrastructure system 110. As another example, the request inventory can include, but is not limited to, vehicle information (e.g., a vehicle identification number, a vehicle type, etc.), a task associated with the vehicle 102, an expected duration to complete performance of the task, a time of day, a date, a number of vehicles, or a combination thereof among others.

In one or more embodiments, the infrastructure-side AVM algorithm 112 is configured to report the inventory of vehicles to be marshaled that are available based on the inventory of vehicles to be marshaled as well as an access-related request (at step 318) for access to a marshaled vehicle. In one or more examples, the access-related request can be made by the requestor and received by the infrastructure system 110 as a user input. For example, the user input can be a wirelessly transmitted request or a physically selected option chosen using the user device. As another example, the access-related request can include, but is not limited one or more vehicle characteristics, a location associated with a performance of the task, a priority associated with the task, a time-related threshold associated with the task, an expected duration to complete performance of the task, or a combination thereof, among others.

The infrastructure-side AVM algorithm 112 is also configured to identify each vehicle of the inventory of vehicles that will be used to satisfy the access-related request at step 320. The infrastructure-side AVM algorithm 112 is further configured to determine whether there are enough vehicles to meet each request (at step 322) in an instance wherein there are multiple requests. In an instance wherein a determination is made that there not enough vehicles to meet each request in an instance wherein there are multiple requests, the infrastructure-side AVM algorithm 112 is configured to determine whether fewer vehicles from the inventory of vehicles can be used to satisfy each request of the multiple requests at step 324. In one or more examples, step 324 is performed based on an inquiry transmitted to the requestor regarding whether fewer vehicles from the inventory of vehicles can be used to satisfy each request of the multiple requests.

In an instance wherein a determination is made that fewer vehicles from the inventory of vehicles cannot be used to satisfy each request of the multiple requests based on the requestor denying the request, a report can be transmitted (at step 310) to the requestor that can include a notification indicating that the request will be scheduled. As an example, the report can cause the parking management process to be re-initiated at step 304. However, in an instance wherein a determination is made that fewer vehicles from the inventory of vehicles can be used to satisfy each request of the multiple requests based on the requestor approving the request, the infrastructure-side AVM algorithm 112 is configured to assign vehicles (at step 326) from the inventory of vehicles to perform the requested task and/or calculate an expected duration to complete performance of the task based on historical task detail.

In one or more examples, the historical task detail can be stored in a second database 328. It is understood that the second database 328 can be provided internally within the infrastructure system 110 itself or externally in relation to the infrastructure system 110. As another example, the historical task detail can include, but is not limited to, timing-related specifics associated with a task such as an expected duration to complete performance of the task. As yet another example, the historical task detail can include metrics associated with historical performance of the task by multiple vehicles such as an average time to complete performance of the task, what is considered a long time to complete performance of the task, and what is considered a quick completion associated with the performance of the task among others. It is understood that both the historical task detail and the request inventory can be stored in the same database. It is understood that the assignment of vehicles from the inventory of vehicles to perform the requested task and/or the calculation of the expected duration to complete performance of the task can be based on the combination of the results of steps 322 and 324. However, it is also understood that the assignment of vehicles from the inventory of vehicles to perform the requested task and/or the calculation of the expected duration to complete performance of the task can be based on the individual results of steps 322 or 324.

The infrastructure-side AVM algorithm 112 is configured to identify and/or quantify vehicles from the inventory of vehicles that have overlapping functionalities related to multiple uses at step 330. The infrastructure-side AVM algorithm 112 is also configured to confirm the compatibility of the multiple-use functionality of each vehicle from the inventory of vehicles for cooperative access (at step 332) to complete the task(s) based on the request inventory and/or the historical task detail. However, it is understood that the confirmation of the compatibility of the multiple-use functionality of each vehicle from the inventory of vehicles for cooperative access to complete the task(s) can be performed in consideration of any basis.

The infrastructure-side AVM algorithm 112 is further configured to take inventory (at step 334) of each identified use as well as the expected duration to complete performance of the use (i.e., task) including the identified multiple uses. The infrastructure-side AVM algorithm 112 is also configured to initiate a use-case series optimization protocol (at step 336). In one or more examples, the use-case series optimization protocol is performed based on the implementation of the neural network and/or the inventory taken at step 334.

The infrastructure-side AVM algorithm 112 is configured to calculate a time to rearrange the position of the vehicle 102 between multiple use-case tasks at step 338. In one or more examples, the calculation of the time to rearrange the position of the vehicle 102 is performed based on the expected duration to complete performance of the use. As another example, the calculation of the time to rearrange the position of the vehicle 102 can also be performed based on a priority and/or requirement associated with the completion of each task. As a further example, the calculation of the time to rearrange the position of the vehicle 102 can also be performed based on a time period the requestor expects the task(s) to be completed within. In one or more embodiments, the infrastructure-side AVM algorithm 112 is configured to constrain the task(s) to a date associated with priority and/or requirement associated with the completion of each task at step 340. In one or more embodiments, the infrastructure-side AVM algorithm 112 is configured to constrain the task(s) to the time period the requestor expects the task(s) to be completed within at step 342.

The infrastructure-side AVM algorithm 112 is also configured to identify an optimal series that is most efficient based on the task(s) expected to be performed including the identified multiple uses at step 344. In one or more examples, the identification of the optimal series that is most efficient can also be based on the time period the requestor expects the task(s) to be completed within, the priority associated with the completion of the task(s), or a combination thereof, among others. The infrastructure-side AVM algorithm 112 is further configured to generate a schedule indicating the next uninterrupted marshaling period at step 346. It is understood that an uninterrupted marshaling period can be defined as a period where no vehicles are added or removed from the marshaling environment.

The infrastructure-side AVM algorithm 112 is additionally configured to cause a report to be transmitted (at step 348) to the requestor(s) indicating the schedule generated at step 346. It is understood that the report transmitted at step 348 can provide an opportunity for the requestor(s) to confirm the schedule generated at step 346. The infrastructure-side AVM algorithm 112 is also configured to determine (at step 350) whether the requestor(s) has confirmed the schedule generated at step 346. In a case wherein the requestor(s) has not confirmed the schedule generated at 346, the infrastructure-side AVM algorithm 112 is configured to remove the requestor's request from the schedule and recalculate the schedule (at step 352) beginning with step 338. In addition to removing the requestor's request from the schedule and recalculating the schedule, a report can be transmitted (at step 310) to the requestor that can include a notification indicating that the request will be scheduled.

However, in a case wherein the requestor(s) has confirmed the schedule generated at 346, the infrastructure-side AVM algorithm 112 is configured to proceed with the performance of the task(s) (at step 354) as scheduled at step 346. In one or more examples, the performance of the task(s) as scheduled at step 346 can proceed after one or more previous tasks associated are completed so that the position of the vehicle 102 can be rearranged to accommodate access for the next task(s). The infrastructure-side AVM algorithm 112 is also configured to cause one or more vehicles associated with the task(s) to move to an exterior zone of the marshaling environment at step 356. It is understood that the one or more vehicles are moved via an automated marshaling means or, in a case wherein the one or more vehicles cannot be marshaled, a manual means by the system operator 106 for example. In one or more examples, the one or more vehicles associated with the task(s) that are caused to move to the exterior zone of the marshaling environment are positioned in an accessible manner (e.g., spacing to allow pedestrians and/or vehicles access between the one or more vehicles).

The infrastructure-side AVM algorithm 112 is further configured to determine whether the requestor is on time at step 358. In a case wherein the requestor is determined to be not on time, the infrastructure-side AVM algorithm 112 is configured to transmit a reminder to the requestor at step 360. However, in a case wherein the requestor is determined to be on time, the infrastructure-side AVM algorithm 112 is configured to transmit a report of completion of the task(s) to the requestor at step 362.

In one or more embodiments, the infrastructure-side AVM algorithm 112 is additionally configured to determine whether vehicles are being added and/or removed from the inventory of vehicles at step 364. In a case wherein the infrastructure-side AVM algorithm 112 determines that vehicles are not being added and/or removed from the inventory of vehicles, the infrastructure-side AVM algorithm 112 is configured to proceed with the performance of the task(s) (at step 354) as scheduled at step 346. However, in a case wherein the infrastructure-side AVM algorithm 112 determines that vehicles are being added and/or removed from the inventory of vehicles, the infrastructure-side AVM algorithm 112 is configured to determine whether the addition and/or removal of the vehicles from the inventory of vehicles affects any of the planned tasks at step 366. In a case wherein the infrastructure-side AVM algorithm 112 determines that the addition and/or removal of the vehicles from the inventory of vehicles does not affect any of the planned tasks, the infrastructure-side AVM algorithm 112 is configured to proceed with the performance of the task(s) (at step 354) as scheduled at step 346. However, in a case wherein the infrastructure-side AVM algorithm 112 determines that the addition and/or removal of the vehicles from the inventory of vehicles affects any of the planned tasks, the infrastructure-side AVM algorithm 112 is configured to cause or the parking management process to be re-initiated at step 304.

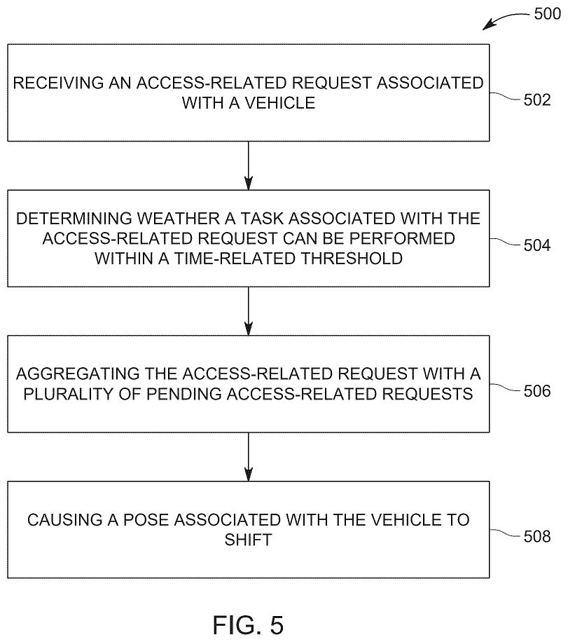

FIG. 5 is a flowchart illustrating an example method 500 for optimizing management associated with parking one or more vehicles within a marshaling environment. At operation 502, an infrastructure system (e.g., the infrastructure system 110) is configured to receive an access-related request associated with a vehicle (e.g., the vehicle 102). In one or more examples, the access-related request can be associated with any vehicle from an inventory of vehicles stored within a marshaling environment or parking zone. As an example, the access-related request includes one or more vehicle characteristics (e.g., a vehicle model, a vehicle year, a vehicle trim, a powertrain type associated with the vehicle, one or more installed options associated with the vehicle, etc.), a location associated with a performance of a first task (e.g., a repair and/or inspection of the vehicle), a priority associated with the first task (e.g., assigned by a requestor indicating a day and/or time the first task is expected to be performed), the time-related threshold associated with the first task, an expected duration to complete performance of the first task, how many vehicles require access (e.g., indicated by a service provider) and what type of access (e.g., software updates, data collection, inspection, replacement of systems/components, etc.), or a combination thereof. As another example, the access-related request can indicate an acceptable deviation from the day and/or time the first task is expected to be performed. It is understood that the time-related threshold can correspond to any range of times. It is also understood that the acceptable deviation can differ from the range associated with the time-related threshold as long as the first task is completed by the expected day and/or time, in which instance the first task will meet or exceed the time-related threshold. As yet another example, in an instance wherein the deviation does not satisfy the time-related threshold, an infrastructure-side AVM algorithm (e.g., the infrastructure-side AVM algorithm 112) is configured to identify whether other service locations are available to cause the vehicle to move to the other service location so that the first task can be completed by the expected day and/or time as is described herein.

At operation 504, the infrastructure system is also configured to determine whether the first task associated with the access-related request can be performed within the time-related threshold. At operation 506, the infrastructure system is additionally configured to aggregate the access-related request with a plurality of pending access-related requests. In one or more examples, the aggregation of the access-related request with the plurality of pending access-related requests is performed in response to determining that the access-related request cannot be performed within the time-related threshold. As another example, each access-related request of the pending access-related requests is associated with a second task. As yet another example, each access-related request of the pending access-related requests includes one or more vehicle characteristics, a location associated with a performance of the second task, a priority associated with the second task, a time-related threshold associated with the second task, an expected duration to complete performance of the second task, or a combination thereof.

At operation 508, the infrastructure system is further configured to cause a pose associated with the vehicle to shift or otherwise change. In one or more examples, the pose is caused to shift in response to the aggregation of the access-related request with the plurality of pending access-related requests. As another example, the pose associated with the vehicle includes a position and a location that corresponds to the vehicle. In one or more examples, causing the pose associated with the vehicle to shift includes the infrastructure system determining a future position and location that allows access for one or more tasks to be performed on another vehicle as well as causing the vehicle to proceed to the future position and location. In one or more examples, the future position and location can be a position that allows for a continuous flow of vehicles in/out of the marshaling environment and provides an opportunity for unique use-cases (e.g., tasks) to be performed on the vehicle without hindering other vehicles' progression through the marshaling environment.

In one or more embodiments, the infrastructure system is configured to determine whether the expected duration to complete performance of the second task satisfies the time-related threshold associated with the first task. The infrastructure system is also configured to cause the second task to be performed in parallel to the first task being performed on the vehicle. In one or more examples, the second task is caused to be performed in response determining that the expected duration to complete performance of the second task satisfies the time-related threshold associated with the first task.

In one or more embodiments, the infrastructure system is configured to assign a priority to one or more parking locations within a marshaling environment. In one or more examples, the assignment of a priority to the one or more parking locations is based on an accessibility associated with each parking location of the one or more parking locations. The infrastructure system is also configured to assign the vehicle to a parking location of the one or more parking locations. As another example, the assignment of the vehicle to the parking location is performed in response to a completion of the first task performed on the vehicle. The infrastructure system is further configured to cause the vehicle to proceed to the parking location. As yet another example, the vehicle is caused to proceed to the parking location in response to the assignment of the vehicle to the parking location. In one or more examples, the assignment of the vehicle to the parking location includes the infrastructure system matching an expected duration of parking the vehicle within the marshaling environment to the assigned priority of the parking location. As another example, the assignment of the vehicle to the parking location can be based on the infrastructure-side AVM algorithm being configured to identify a future-intended use of the vehicle and prioritize different parking locations based on the future-intended use of the vehicle. In other words, the infrastructure-side AVM algorithm is configured to dynamically assign the vehicle and cause the vehicle to move to a parking location based on a prioritization or a de-prioritization of the task(s) associated with the vehicle. For example, in a case wherein the vehicle requires a prioritized parking location, the vehicle will be caused to move to a parking location that is easily accessible. However, in another example and in a case wherein the vehicle requires a de-prioritized parking location, the vehicle will be caused to move to a parking location that is not as easily accessible.

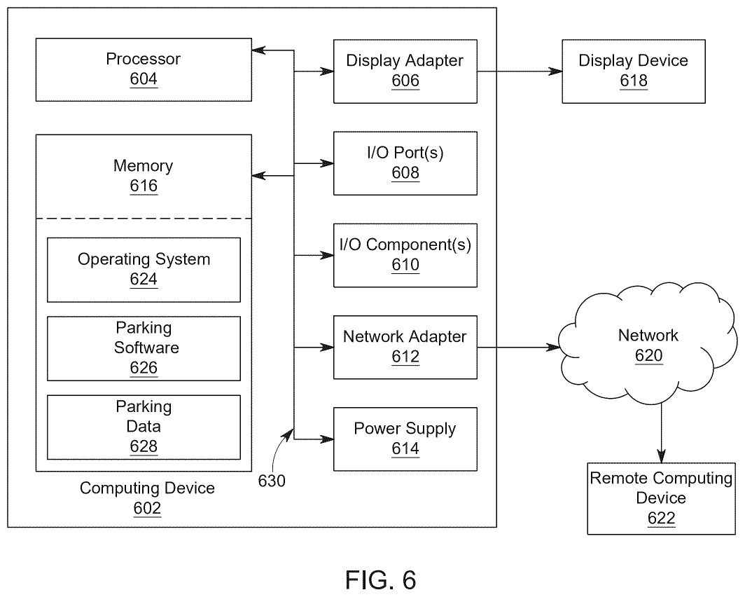

FIG. 6 illustrates an operating environment, such as a computer system, that facilitates the performance of one or more systems and methods described herein. More specifically, the systems and methods described herein can be implemented using a computing device 602. For example, the computing device 602 can be a personal computer, a desktop, a laptop, a tablet, a hand-held computer, a server, a workstation, a mainframe, a wearable computer, a supercomputer, or a combination thereof. However, it is understood that the aforementioned examples of the computing device 602 is non-exhaustive and the computing device 602 can be any type of processing or computing device. The computing device 602 generally includes a processor 604, a display adapter 606, one or more input/output port(s) 608, one or more input/output component(s) 610, a network adapter 612, a power supply 614, and a memory 616. However, it is understood that the computing device 602 can include any additional components therein and is not required to include any of the listed components (e.g., the processor 604, the display adapter 606, the one or more input/output port(s) 608, the one or more input/output component(s) 610, the network adapter 612, the power supply 614, and the memory 616).

The processor 604 is configured to provide instructions to the computing device 602 so that the computing device 602 can process one or more tasks including the implementation of a software program to perform one or more operations as described in more detail herein. It is also understood that the computing device 602 may include any number or processors 604 therein. The display adapter 606 can be a graphics card or a video board that provides the computing device 602 with a capability to display content on a display device 618. For example, the display device 618 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of the display device 618 is non-exhaustive and that the display device 618 can be any type of device capable of providing a visual display.

The input/output port(s) 608 provide a number of interfaces (e.g., sockets) for one or more cables to connect to the computing device 602. It is understood that there may be any number of input/output port(s) 608 on the computing device 602. For example, the input/output port(s) 608 provides a means for the computing device 602 to receive signals and/or data from an external device connected to the computing device 602 via the one or more cables. As another example, the input/output port(s) 608 provide a means for the computing device 602 to send signals and/or data to an external device connected to the computing device 602 via the one or more cables. The input/output component(s) 610 can include one or more components that support the input/output port(s) 608 such as, but not limited to, a switch, a push button, a pressure mat, a float switch, a keypad, a radio receive, or a combination thereof.

The network adapter 612 can be any type of network interface controller that is configured to provide a means for communicating over a network 620 with another computing device, such as a remote computing device 622. For example, the remote computing device 622 can be a user device such as a cellular-phone, a smartphone, a tablet, a laptop, or a combination thereof. The power supply 614 is configured to convert alternating high voltage current (e.g., AC) into direct current (e.g., DC) to provide power to the other components (e.g., the processor 604, the display adapter 606, the one or more input/output port(s) 608, the one or more input/output component(s) 610, the network adapter 612, and the memory 616) of the computing device 602.

Additionally, the memory 616 can be a mass storage device and/or a system memory such as a hard disk drive, a memory card, a solid-state drive, RAM, or a combination thereof. The memory 616 is configured to provide storage for instructions and data associated with the operation of the computing device 602. The memory 616 can generally include an operating system 624, parking software 626, and parking data 628 to perform one or more operations described in more detail herein. For example, the operating system 624 is configured to manage and/or process any of the data and/or instructions associated with the parking software 626 and/or the parking data 628, as described in more detail herein.

Furthermore, a system bus 630 is also included within the computing device 602 that is configured to couple each of the various components (e.g., the processor 604, the display adapter 606, the one or more input/output port(s) 608, the one or more input/output component(s) 610, the network adapter 612, the power supply 614, and the memory 616) of the computing device 602. It is also understood that each of the components of the computing device 602, and the functionality associated with each of the components of the computing device 602, may be implemented within the remote computing device 622. While the operating environment illustrated within FIG. 6 depicts a particular configuration associated with at least the computing device 602, the network 620, and the remote computing device 622, it is understood that the operating environment may be configured in any way.

Thus, one or more examples of the present disclosure provide a means for optimizing a parking management system through the utilization of one or more methods and systems described herein that employ the use of an infrastructure-side automated vehicle marshaling algorithm. The one or more examples provide accessibility to a vehicle amongst a plurality of vehicles located within a parking location of a marshaling environment based on one or more use-cases associated with the vehicle.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method comprising:
receiving, by an infrastructure system, an access-related request associated with a vehicle;
determining whether a first task associated with the access-related request can be performed within a time-related threshold;
aggregating the access-related request with a plurality of pending access-related requests in response to determining that the access-related request cannot be performed within the time-related threshold; and
causing a pose associated with the vehicle to shift in response to the aggregation of the access-related request with the plurality of pending access-related requests.

2. The method of claim 1, wherein the access-related request includes one or more vehicle characteristics, a location associated with a performance of the first task, a priority associated with the first task, the time-related threshold associated with the first task, an expected duration to complete performance of the first task, or a combination thereof.

3. The method of claim 1, wherein each access-related request of the pending access-related requests is associated with a second task, and wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof.

4. The method of claim 3, further comprising:
determining whether the expected duration to complete performance of the second task satisfies the time-related threshold associated with the first task; and
causing the second task to be performed in parallel to the first task being performed on the vehicle in response to determining that the expected duration to complete performance of the second task satisfies the time-related threshold associated with the first task.

5. The method of claim 1, further comprising:
assigning a priority to one or more parking locations within a marshaling environment based on an accessibility associated with each parking location of the one or more parking locations;
assigning the vehicle to a parking location of the one or more parking locations in response to a completion of the first task performed on the vehicle; and
causing the vehicle to proceed to the parking location in response to the assignment of the vehicle to the parking location.

6. The method of claim 5, wherein the assignment of the vehicle to the parking location further comprises:
matching an expected duration of parking the vehicle within the marshaling environment to the assigned priority of the parking location.

7. The method of claim 1, wherein the pose associated with the vehicle includes a position and a location that corresponds to the vehicle, and wherein causing the pose associated with the vehicle to shift further comprises:
determining a future position and location that allows access for one or more tasks to be performed on another vehicle; and
causing the vehicle to proceed to the future position and location.

8. A system comprising:
an infrastructure system configured to:
receive an access-related request associated with a vehicle,
determine whether a first task associated with the access-related request can be performed within a time-related threshold,
aggregate the access-related request with a plurality of pending access-related requests in response to determining that the access-related request cannot be performed within the time-related threshold, and
cause a pose associated with the vehicle to shift in response to the aggregation of the access-related request with the plurality of pending access-related requests; and
the vehicle configured to:
receive, from the infrastructure system, one or more marshaling commands, and
shift the pose associated with the vehicle in response to receiving the one or more marshaling commands.

9. The system of claim 8, wherein the access-related request includes one or more vehicle characteristics, a location associated with a performance of the first task, a priority associated with the first task, the time-related threshold associated with the first task, an expected duration to complete performance of the first task, or a combination thereof.

10. The system of claim 8, wherein each access-related request of the pending access-related requests is associated with a second task, and wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof.

11. The system of claim 10, wherein the infrastructure is further configured to:
determine whether the expected duration to complete performance of the second task satisfies the time-related threshold associated with the first task; and
cause the second task to be performed in parallel to the first task being performed on the vehicle in response to determining that the expected duration to complete performance of the second task satisfies the time-related threshold associated with the first task.

12. The system of claim 8, wherein the infrastructure is further configured to:
assign a priority to one or more parking locations within a marshaling environment based on an accessibility associated with each parking location of the one or more parking locations;
assign the vehicle to a parking location of the one or more parking locations in response to a completion of the first task performed on the vehicle; and
cause the vehicle to proceed to the parking location in response to the assignment of the vehicle to the parking location.

13. The system of claim 12, wherein the infrastructure system configured to assign the vehicle to the parking location is further configured to:
match an expected duration of parking the vehicle within the marshaling environment to the assigned priority of the parking location.

14. The system of claim 8, wherein the pose associated with the vehicle includes a position and a location that corresponds to the vehicle, and wherein the infrastructure system configured to cause the pose associated with the vehicle to shift is further configured to:
determine a future position and location that allows access for one or more tasks to be performed on another vehicle; and
cause the vehicle to proceed to the future position and location.

15. One or more non-transitory computer-readable media storing processor-executable instructions that, when executed by at least one processor, cause the at least one processor to:
receive an access-related request associated with a vehicle;
determine whether a first task associated with the access-related request can be performed within a time-related threshold;
aggregate the access-related request with a plurality of pending access-related requests in response to determining that the access-related request cannot be performed within the time-related threshold; and
cause a pose associated with the vehicle to shift in response to the aggregation of the access-related request with the plurality of pending access-related requests.

16. The one or more non-transitory computer-readable media of claim 15, wherein the access-related request includes one or more vehicle characteristics, a location associated with a performance of the first task, a priority associated with the first task, the time-related threshold associated with the first task, an expected duration to complete performance of the first task, or a combination thereof, and wherein each access-related request of the pending access-related requests is associated with a second task, and further wherein each access-related request of the pending access-related requests includes one or more vehicle characteristics, a location associated with a performance of the second task, a priority associated with the second task, a time-related threshold associated with the second task, an expected duration to complete performance of the second task, or a combination thereof.

17. The one or more non-transitory computer-readable media of claim 16, wherein the at least one processor is further caused to:
determine whether the expected duration to complete performance of the second task satisfies the time-related threshold associated with the first task; and
cause the second task to be performed in parallel to the first task being performed on the vehicle in response to determining that the expected duration to complete performance of the second task satisfies the time-related threshold associated with the first task.

18. The one or more non-transitory computer-readable media of claim 15, wherein the at least one processor is further caused to:
assign a priority to one or more parking locations within a marshaling environment based on an accessibility associated with each parking location of the one or more parking locations;
assign the vehicle to a parking location of the one or more parking locations in response to a completion of the first task performed on the vehicle; and
cause the vehicle to proceed to the parking location in response to the assignment of the vehicle to the parking location.

19. The one or more non-transitory computer-readable media of claim 18, wherein the at least one processor caused to assign the vehicle to the parking location is further caused to:
match an expected duration of parking the vehicle within the marshaling environment to the assigned priority of the parking location.

20. The one or more non-transitory computer-readable media of claim 15, wherein the pose associated with the vehicle includes a position and a location that corresponds to the vehicle, and wherein the at least one processor caused to cause the pose associated with the vehicle to shift is further caused to:
determine a future position and location that allows access for one or more tasks to be performed on another vehicle; and
cause the vehicle to proceed to the future position and location.
